(19) United States
(12) Patent Application Publication
(10) Pub. No.: US 2015/0014077 A1
(43) Pub. Date: Jan. 15, 2015

(54) METHOD-SYSTEM OF PARKING A VEHICLE USING ONLY FRONT ROAD COURSE AND PLACEMENT OF THE REAR OF THE VEHICLE IN A FINAL PARKING POSITION BY AN AUXILIARY MECHANISM

(71) Applicant: Panagiotis Tsitimakis, Venezia (IT)

(72) Inventor: Panagiotis Tsitimakis, Venezia (IT)

(21) Appl. No.: 14/379,618

(22) PCT Filed: Feb. 23, 2012
(86) PCT No.: PCT/GR2012/000007

§ 371 Date: Aug. 19, 2014

(51) Int. Cl. B60S 9/215; B60S 9/21; B60S 9/205

(52) U.S. Cl. CPC B60S 9/215; B60S 9/205; B60S 9/21
USPC 180/199

(57) ABSTRACT

Method-system of parking a vehicle using only front road course and placement of the rear of the vehicle in a final parking position by an auxiliary mechanism. A method-system of parking a vehicle along parking provision, where the only thing that the driver has to do is to place the front of the vehicle, using front road course, both near to the front parked vehicle, as well as to the clay of the pavement. The installation of the rear of the vehicle to the final position for the vehicle's immobilization, occurs by an auxiliary side shift mechanism mounted to the back and lower part of the rear of the vehicle. The auxiliary facility consists of one or more wheels, of a relatively small diameter, and, as for their movement, are vertically installed to the stable wheels of the vehicle. They are also connected to the lower part of a mechanism that can lift enough the vehicle; in order the side shift is capable, when the order is given. The whole system of the wheels and lifting mechanism is placed in operation status through descend or withdrawal, only after giving an order, so not to be exposed when it is not functioning.

The invention relates to a method-a system of vehicle parking along the road layout which is opposed to the currently used, as the current method involves, firstly the placing of the vehicle next to the front parked vehicle and secondly, putting it in the parking lot using reverse course to the final position for its immobilization.

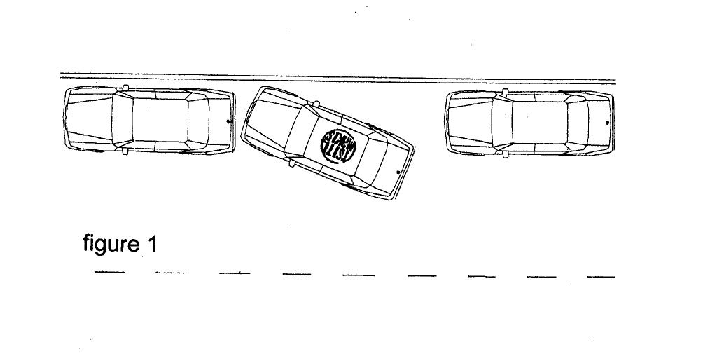

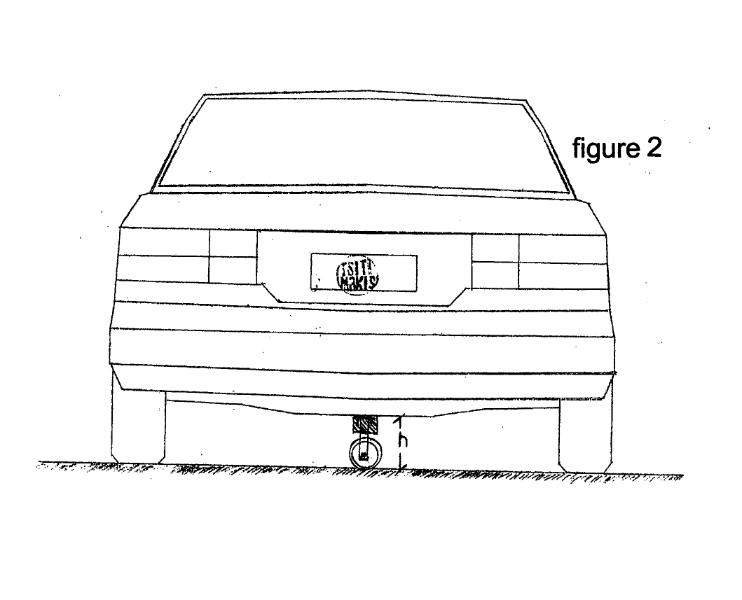

In opposition, with the suggested method is enough the placement of the vehicle by the driver through forward course, until approaching the front of the vehicle at the rear of the front vehicle parked to the gutter of the sidewalk, as shown in FIG. 1. The placement of the rear of the vehicle to its final position for its immobilization, i.e. the approach to curb the pavement, is made from an auxiliary mechanical system installed at the rear of the vehicle. This auxiliary system consists of one or more wheels, relatively of small diameter, placed perpendicular to their motion towards the wheels of the vehicle and the lifting mechanism, able to lift and then shift laterally (sideway), the rear of the vehicle [FIG. 2].

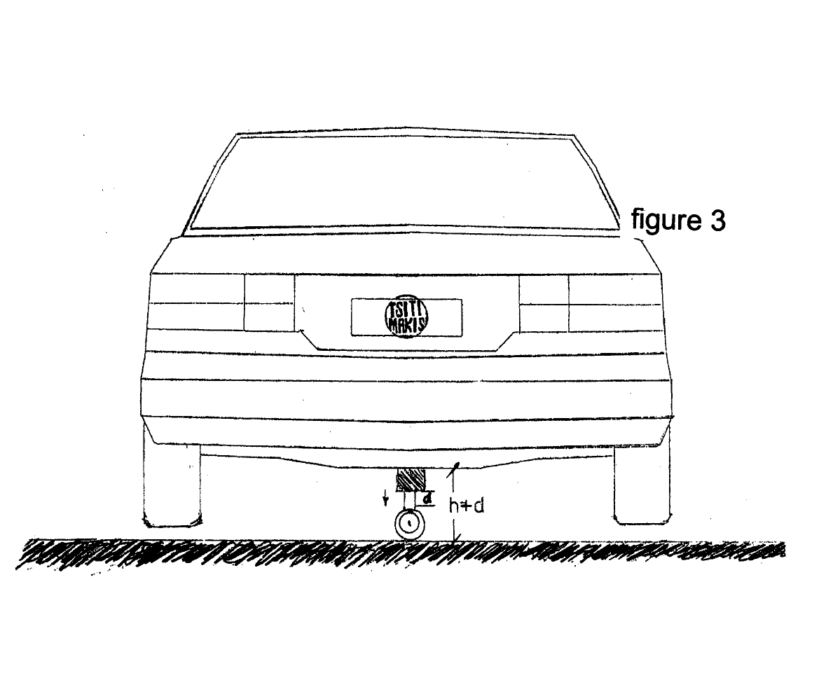

The complex of the wheel (or wheels) and the lifting mechanism is in operating position, through a mechanism of descent or folding or tilting of the system that is located or ordered by the driver or by automation in the position below and behind the vehicle, as shown in FIG. 2. So when is given the order, the mechanism which is already lowered or folded or tilted to the operating position, at the rear of the vehicle, activates the lift system, which through its elongation reaches to suspend almost the entire weight of the rear of the vehicle onto the wheel, as shown in FIG. 3.

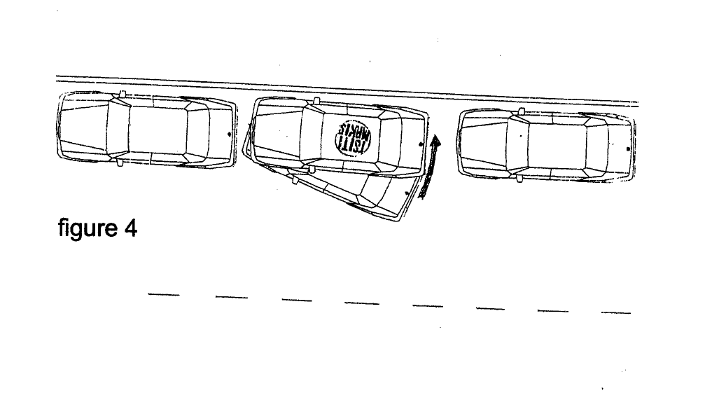

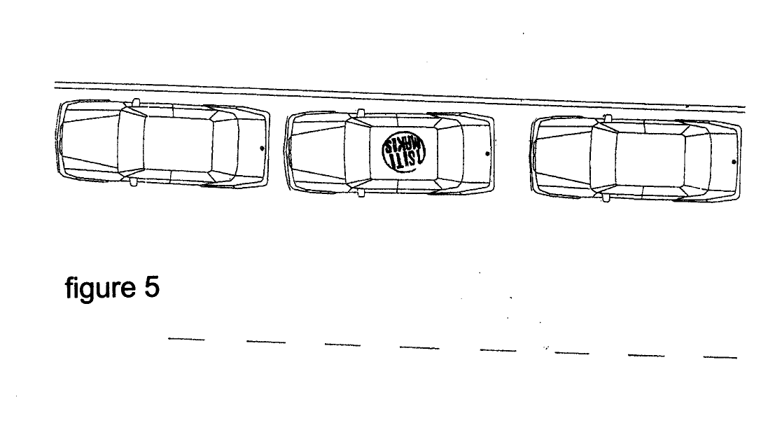

Thereby allows the side shift of the rear of the vehicle in order to approach the kennel [FIG. 4]. The above kit can, regarding its movement, be an electric or hydraulic or of compressed air, or mechanical. It's important to be specified with accuracy its movement through instructions given from the driver or by sensors and controls. If, however, is asked the most economical solution, the kit can be manual and the shift can be done by the driver.

Also, as for the exit of the parking ramp/space, if there is not enough room to move backwards the vehicle and come out with forward course, the mechanism can be used vice versa and the vehicle can leave out by reversing. Or there is a possibility to exist a corresponding mechanism as well as in the front of the vehicle that allows the side shift of the front of the vehicle from the sidewalk to the street. Also rather than relying on a wheel, the support may be two or more wheels, if it is required by the vehicle's weight, or depending on occasional conditions, such as if is required the use of the system in circumstances where the slope of the ramp is more than a few degrees so as to create a shifting risk, because of slipping at the phase of elevation/lifting. In this case, it is necessary to place a crawler mechanism in the position of the wheel. In any case it is needed the placement of a mechanism that prevents the operation of the system beyond a certain slope and alerts the driver.

The main advantage of this method is that the driver puts the vehicle only in forward course and then, the completion of the parking procedure takes over the parking automation system. In this way, the driver, whenever moves in reverse the vehicle, is not obliged to try to keep the distances from adjacent parked vehicles and the pavement, and place the vehicle in such a way so that, with the next manoeuvre to complete the park.

Far more important however is, the help that is offered by this system in older people or in people of reduced mobility. Also with the help of appropriate sensors, parking will be possible in a very limited space, compared to vehicle size, as well as the time and energy saving.

1. Method-system, for parking a vehicle along the road, layout parking of vehicles, either on the right or left side of the road [FIG. 1]. Lies in the placement, by using front road course of the front of the vehicle by the driver, as close as possible, both in front of parked vehicle and secondly, as close as possible to the red clay of the pavement [FIG. 1]. The completion of the placement of the vehicle to the final parking position, ie parallel to the red clay of the sidewalk, is made by a helping side shift mobile device of the rear of the vehicle, with the assistance of appropriate sensors in order to be achieved the exact position [FIG. 4]. The side shift of the rear of the vehicle can be done either towards left or right depending on the circumstances.

2. The auxiliary mechanism of the side shift of the vehicle which is mentioned in the main claim, consists of wheel, a relatively small diameter, connected to the vehicle body at the bottom or back through adequate mechanism for lowering or tilting, so that when placed in operating position, to be perpendicular to the rear wheels of the vehicle in its motion [FIG. 2]. Once is downloaded, or tilted the auxiliary mechanism, lifts the rear of the vehicle enough, in order to allow, rotating the wheel, to shift it, to the red clay of the pavement [FIG. 4]. The downward movement or lifting of the auxiliary mechanism as well as the wheel rotation can be controlled by the driver or by automations through appropriate sensors. Depending on the size and weight of the vehicle, it is likely the auxiliary mechanism to be composed of several wheels and mechanical lifting systems.

3. The auxiliary mechanism of the side shift of the vehicle mentioned in the main claim, comprises of caterpillar mechanism for the sidle, connected to the body with an appropriate descent or lift mechanism at the rear underside of the vehicle so that when is placed in operating position, to be perpendicular/vertical to the rear wheels the vehicle. Once is downloaded, or is lifted, the auxiliary mechanism lifts the rear of the vehicle enough to allow the moving caterpillar to displace the vehicle until the red clay of the sidewalk. The movement of all may be controlled by the user or through automation sensors. Depending on the size and weight of the vehicle, it is likely the auxiliary mechanism to be composed of more than one caterpillar and mechanical lifting systems.

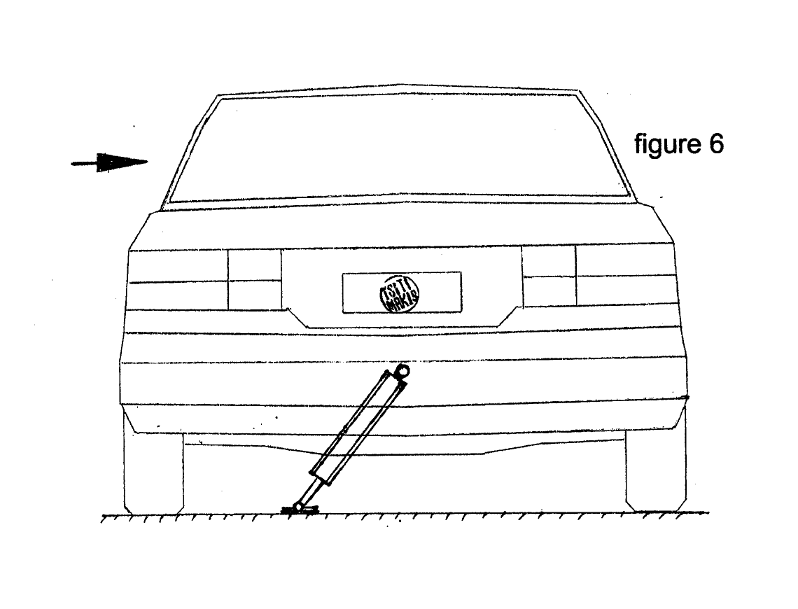

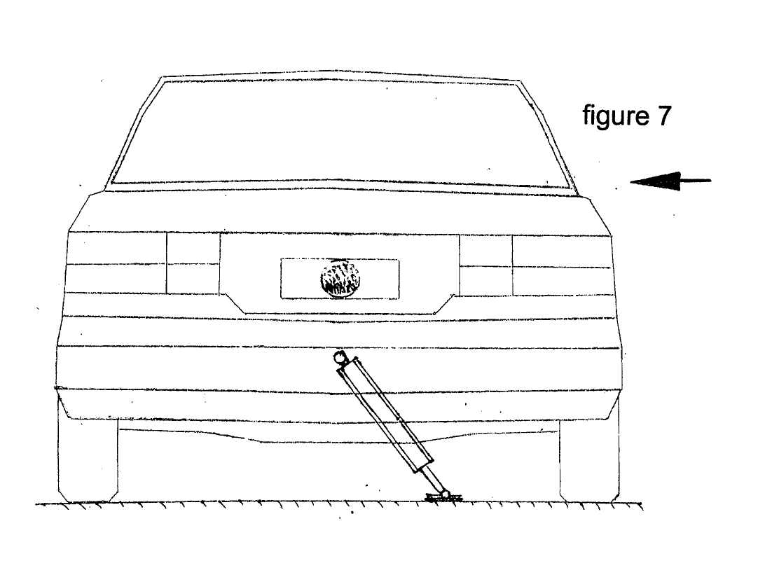

4. The auxiliary mechanism of the side shift of the vehicle mentioned in the main claim, consists of lengthening rod [FIGS. 6 and 7] which is supported on its top edge at one base that allows the pendulum motion and the motion of the oscillation to be perpendicular to the rear wheels of the vehicle. So when it is placed in operating position, depending on the circumstances, inclined to the right or left, is stretched after being stabilized on the ground the other end. As the rod lengthens, the rear of the vehicle is lifted until the rear wheels reach a loss of traction with the ground, resulting the vehicle's skidding sideway on the red clay pavement.

5. The auxiliary mechanism of side shift of the vehicle can be posted as well as in the front of the vehicle in order to move the vehicle sideway, in the final vehicle parking position, and at the departure, to facilitate the exit.

6. The side shift of a conventional vehicle size, can be done manually, if the jack is stabilized onto a small metal platform with at least three wheels, and of course more, allowing it to move perpendicularly/vertically to the movement of the rear wheels of the vehicle. (Assuming, of course, that at the lower rear of the vehicle, exists an appropriate position for its placement). Once is lifted the vehicle from the jack, which is posted on the platform, it is possible the side shift/relocation of the vehicle to be done manually by the driver.
